(19) United States
(12) Patent Application Publication
(10) Pub. No.: US 2026/0213918 A1
(43) Pub. Date: Jul. 23, 2026

(54) METHOD AND SYSTEM FOR PROVIDING EFFICIENT QUANTUM PROOF ENCRYPTION USING BOOLEAN GATES WITH REDUCED BOOTSTRAPPING

(71) Applicant: Cornami, Inc., Dallas, TX (US)

(72) Inventor: Denis Ovchinnikov, Dallas, TX (US)

(21) Appl. No.: 19/035,431

(22) Filed: Jan. 23, 2025

(51) Int. Cl. H04L 9/00

(52) U.S. Cl. CPC H04L 9/008

(57) ABSTRACT

A system and method to reduce the number of bootstraps required for performing Boolean operations on ciphertexts using Fully Homomorphic Encryption over the Torus (tFHE). A modulo is determined for a plurality of encrypted ciphertexts. False is assigned to a first value and true is assigned to a second value. A Boolean expression including the plurality of ciphertexts is converted into a mathematical function and each of the possible outputs of the function is mapped to the first value or the second value. A first outcome value is assigned to the result of the mathematical function when the Boolean expression evaluates to true. A second outcome value is assigned to each of a set of results of the mathematical function when the Boolean expression evaluates to false. The number of bootstraps required is reduced based on only having to bootstrap the first and second outcome values.

### TECHNICAL FIELD

The present disclosure relates generally to security applications. More particularly, aspects of this disclosure relate to techniques to reduce computations for encryption that is resistant to quantum computing.

### BACKGROUND

Computing systems are increasing based on homogeneous cores that may be configured for different executing applications. Thus, such cores may be adapted for many different operations and be purposed for various parallel programming tasks. The cores are typically fabricated on a die. Such dies may be fabricated so they may be divided to allocate the needed processing power. The processing performed by such dies thus relies on many cores being employed to divide programming operations. One example of such division may be a streaming model of programming multiple cores that employs different threads that are assigned to different cores.

Such dies therefore have an array of cores that may be selectively employed for different operations such as for massively parallel processing. One application of dies with a large array of cores may be for security applications such as encrypting and decrypting data. The parallel nature of encryption applications may leverage the configurable nature of the architecture of an array of homogeneous configurable cores.

Currently, encryption techniques relate to public/private key mechanisms that require an intensive level of computing power to brute force solve the encryption. Such systems are currently secure because of the corresponding intensive level of computing power necessary to solve such encryption. However, with the advent of potential quantum computers, standard encryption techniques may be vulnerable to being solved by a quantum computer. Thus, new types of encryption have been proposed such as fully homomorphic encryption (FHE), that is quantum secure scheme. FHE allows computations on ciphertext without having to perform decryption. This allows delegation of sensitive data analysis computations on encrypted data. One type of fully homomorphic encryption is the Concrete library that implements the Fully Homomorphic Encryption over the Torus (TFHE) procedure.

The Concrete library is an open-source library developed in Rust that builds on the state-of-art TFHE cryptosystem. The Concrete library provides a user friendly interface making FHE easy to integrate. The Concrete library deals with inputs of arbitrary format and comes with an extensive set of operations for manipulating ciphertexts, including a programmable bootstrapping process. Learning With Errors (LWE) is a quantum robust method of cryptography applicable to FHE that is conjectured to be hard to solve, and thus to be useful in cryptography. FHE is based on a quantum secure scheme based on the LWE problem (learning with errors). The FHE allows computations such Boolean operations on ciphertext with decryption. Thus, sensitive data analysis (computations) may be delegated on encrypted data.

Currently TFHE/Concrete Boolean operations require bootstrapping after each Boolean operation between 2 bits in order to eliminate the effects of noise on the integrity of the encryption. Thus, current Concrete operations require a large amount of computation power when performing consecutive Boolean operations due to the requirement of bootstrapping. This is common in applications that utilize the Concrete library. Since bootstrapping is by far the most expensive operation in the TFHE/Concrete scheme (requiring 75-95% of computational power), bootstrapping needs to be reduced to make the Concrete operations efficient and thus practical for security applications.

Any function may be evaluated using programmable bootstrapping assuming the leading bit is known. For example, if the ciphertext is mod 8. The function where 0 is 0, 1 is 1, 2 is 2, and 3 is 3 may be evaluated for normal bootstrapping. Thus, the 3 Boolean variables in the example function require three bootstraps to perform the evaluation of the Boolean operation. The function may also be evaluated where 0 is 1, 1 is 1, 2 is 1, and 3 is 1. This automatically sends 4 to −1, 5 to −1, 6 to −1 and 7 to −1 (0≤x<4) and thus only one bootstrap is required because certain Boolean variables may be grouped. In existing implementations, this function is combined with encryption true is 1 and false is −1, and every Boolean operation is modeled by a linear combination of corresponding ciphertexts. This implies that bootstrapping is required after every Boolean operation as otherwise it cannot be ensured the bootstrapping function evaluates the required Boolean operation correctly.

Thus, there is a need for a technique for reducing the number of bootstraps required for TFHE/Concrete Boolean operations. There is also a need for a reduced bootstrapping scheme that may be applied to a variety of Boolean operations for FHE type cryptography.

### SUMMARY

One disclosed example is a method to perform operations on ciphertext using Fully Homomorphic Encryption (FHE). A modulo is determined for a plurality of ciphertexts. False is assigned to a first value and true is assigned to a second value. Each of a plurality of ciphertexts is mapped to the first value or the second value. A Boolean expression including the plurality of ciphertexts is converted into a mathematical function. A first outcome value is assigned to a result of the mathematical function for a first result of the Boolean expression where the ciphertexts are a first combination of true or false. A second outcome value is assigned to each of a plurality of second results of the mathematical function for the Boolean expression where the ciphertexts are combinations of being true or false. The reduced first and second outcome values of the mathematical function converted from the Boolean expression are bootstrapped.

A further implementation of the example method is where the modulo is mod 8, and wherein the first value is 0 and the second value is 1. Another implementation is where the plurality of ciphertexts are represented by c1, c2, and c3. The Boolean expression is expressed as c1 OR c2 OR c3, and evaluating c1+c2+c3 yields the first outcome value is a 0 if all the ciphertexts are false; and yields the second outcome value is a 1 if the results are a 1, 2, or 3 representing at least one of the ciphertexts are true. Another implementation is where the plurality of ciphertexts are represented by c1, c2, and c3. The Boolean expression is a majority function of c1, c2, and c3. Evaluating c1+c2+c3 yields the first outcome value is a 0 if the result is 0 or 1 representing that at most one of the ciphertexts is true; and yields the second outcome value is a 1 if the results are a 2 or 3, representing at least two of the ciphertexts are true. Another implementation is where the Boolean expression includes at least one of XOR, AND, or NAND Boolean operations. Another implementation is where the Boolean expression is a full adder formed from XOR, AND, and Majority function Boolean operations. Another implementation is where the modulo is mod 16, and where the first value is −1 and the second value is 1. Another implementation is where the Boolean expression and encryption of the ciphertexts are performed by configured cores in an array of configurable cores. Another implementation is where the cyphertexts are encrypted data, and the Boolean expression is performed without decrypting the encrypted data.

Another disclosed example is a system to perform operations on encrypted ciphertext using Fully Homomorphic Encryption (FHE) based on a determined modulo and an assignment of false to a first value and true to a second value. The system includes a first configuration of programmable cores providing encryption to create a plurality of ciphertexts and assigning the first or second value to each of the plurality of ciphertexts based on the determined modulo. The system includes a second configuration of programmable cores converting a Boolean expression including the plurality of ciphertexts into a mathematical function and assigning a first outcome value to the result of the mathematical function for a first result of the Boolean expression where the ciphertexts are a first combination of true or false. A second outcome value is assigned to each of a plurality of second results of the mathematical function for the Boolean expression where the ciphertexts are combinations of being true or false. A third configuration of programmable cores perform a programmable bootstrapping to reduce noise level in the ciphertext for a specified first and second results of the mathematical function.

A further implementation of the example system is where the modulo is mod 8, and the first value is 0 and the second value is 1. Another implementation is where the plurality of ciphertexts are represented by c1, c2, and c3. The Boolean expression is expressed as c1 OR c2 OR c3. Evaluating c1+c2+c3 yields the first outcome value is a 0 if all the ciphertexts are false; and yields the second outcome value is a 1 if the results are a 1, 2, or 3 representing at least one of the ciphertexts are true. Another implementation is where the plurality of ciphertexts are represented by c1, c2, and c3. The Boolean expression is a majority function of c1, c2, and c3. Evaluating c1+c2+c3 yields the first outcome value is a 0 if the result is 0 or 1 representing that at most one of the ciphertexts is true; and yields the second outcome value is a 1 if the results are a 2 or 3, representing at least two of the ciphertexts are true. Another implementation is where the Boolean expression includes at least one of XOR, AND, or NAND Boolean operations. Another implementation is where the Boolean expression is a full adder formed from XOR, AND, and Majority function Boolean operations. Another implementation is where the modulo is mod 16, and wherein the first value is −1 and the second value is 1. Another implementation is where the cyphertexts are encrypted data, and wherein the Boolean expression is performed without decrypting the encrypted data.

Another disclosed example is a non-transitory computer readable medium having stored software instructions that, when executed by a processor, cause the processor to determine a modulo for a plurality of ciphertexts and assign false to a first value and true to a second value. The instructions cause the processor to map each of a plurality of ciphertexts to the first value or the second value. The instructions cause the processor to convert a Boolean expression including the plurality of ciphertexts into a mathematical function. The instructions cause the processor to assign a first outcome value to the result of the mathematical function for a first result of the Boolean expression where the ciphertexts are a first combination of true or false, and assign a second outcome value to each of a plurality of results of the mathematical function for a set of results of the Boolean expression where the ciphertexts are combinations of being true or false. The instructions cause the processor to bootstrap the reduced first and second outcome values of the mathematical function converted from the Boolean expression.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1A is a diagram of a chip having four dies each having multiple processing cores;

FIG. 1B is a simplified diagram of one of the dies on the chip shown in FIG. 1A;

FIG. 2A is a block diagram of the array of cores in the die in FIG. 1B;

FIG. 2B is a three-dimensional view of the array of cores in the die in FIG. 1B;

FIG. 3 is a three-dimensional view of the array of cores that is suitable for selection for implementation of different operations;

FIG. 4 is an example reconfigurable arithmetic engine configuration of one of the cores in the core array in FIG. 2A;

FIG. 5 is a diagram of configurations of the array of cores in FIG. 2A as either a RISC-V or a specialized ALU internal module;

FIG. 6 is a graph comparing standard encoding with the example encoding process with the example reduced bootstrapping method;

FIG. 7 is a table showing the bootstrapping requirements of different Boolean functions when utilizing the example method;

FIG. 8A is an example logic layout of a prior art adder that requires bootstrapping for each Boolean gate;

FIG. 8B is an example alternate logic layout of the example adder in FIG. 8A that reduces the Boolean operations and thus may be operated with reduced bootstrapping;

FIG. 9 is an example configuration of the array of cores in FIG. 2A for the example FHE method reducing bootstrapping; and

FIG. 10 is a flow diagram of a routine to reduce bootstrapping in FHE.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements, and limitations that are disclosed, for example, in the Abstract, Summary, and Detailed Description sections, but not explicitly set forth in the claims, should not be incorporated into the claims, singly, or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure is directed toward an example technique for different encoding of Boolean values in a Fully Homomorphic Encryption over the Torus (TFHE)/Concrete cryptographic scheme by using precision bits. Under certain conditions, using this encoding and programmable bootstrapping (PBS) makes it possible to perform several Boolean operations before needing to bootstrap during the cryptographic operations of TFHE. The reduction in the need to perform bootstraps increases the speed of the cryptographic operations and saves computational resources normally devoted to performing bootstrapping. The technique may be implemented ideally on an array of homogeneous cores that can each perform parts of the cryptographic encryption operations on ciphertext and then logic operations involving the fully encrypted ciphertext with reduced bootstrapping operations.

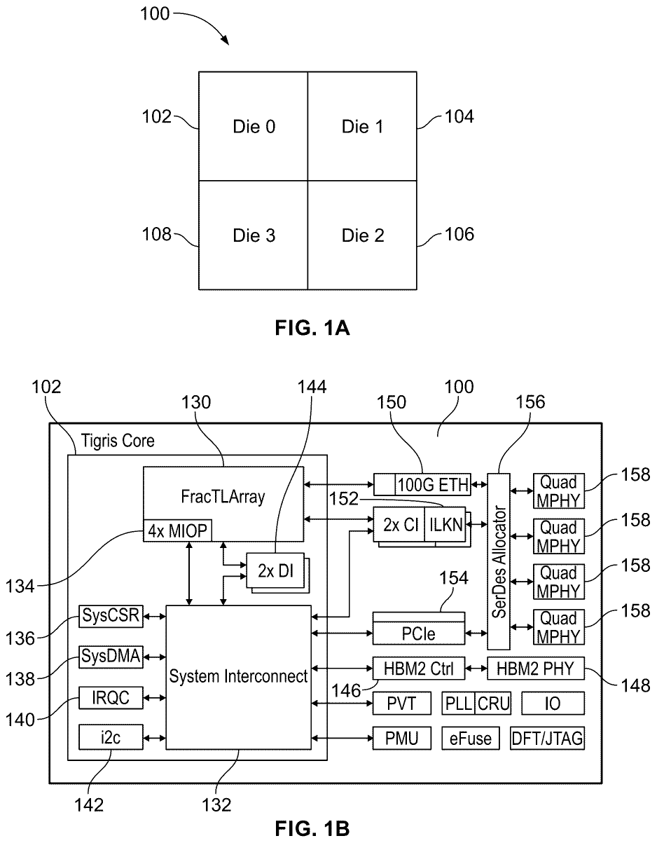

FIG. 1A shows an example chip 100 that is subdivided into four identical dies 102, 104, 106, and 108. Each of the dies 102, 104, 106, and 108 include multiple processor cores, support circuits, serial interconnections and serial data control subsystems. For example, the dies 102, 104, 106, and 108 may each have 4,096 processing cores as well as SERDES interconnection lanes to support different communication protocols. There are die to die parallel connections between the dies 102, 104, 106 and 108. Thus, each of the dies 102, 104, 106, and 108 in this example are interconnected by Interlaken connections. The chip 100 is designed to allow one, two or all four of the dies 102, 104, 106, and 108 to be used. The pins on a package related to un-used dies are left unconnected in the package or the board. The dies are scalable as additional chips identical to the chip 100 may be implemented in a device or a circuit board. In this example, a single communication port such as an Ethernet port is provided for the chip 100. Of course, other ports may be provided, such as one or more ports for each die.

FIG. 1B is a block diagram of one example of the die 102. The die 102 includes a fractal array 130 of processing cores. The processing cores in the fractal array 130 are interconnected with each other via a system interconnect 132. The entire array of cores 130 serves as the major processing engine of the die 102 and the chip 100. In this example, there are 4096 cores in the fractal array 130 that are organized in a grid.

The system interconnection 132 is coupled to a series of memory input/output processors (MIOP) 134. The system interconnection 132 is coupled to a control status register (CSR) 136, a direct memory access (DMA) 138, an interrupt controller (IRQC) 140, an I2C bus controller 142, and two die to die interconnections 144. The two die to die interconnections 144 allow communication between the array of processing cores 130 of the die 102 and the two neighboring dies 104 and 108 in FIG. 1A.

The chip includes a high bandwidth memory controller 146 coupled to a high bandwidth memory 148 that constitute an external memory sub-system. The chip also includes an Ethernet controller system 150, an Interlaken controller system 152, and a PCIe controller system 154 for external communications. In this example each of the controller systems 150, 152, and 154 have a media access controller, a physical coding sublayer (PCS) and an input for data to and from the cores. Each controller of the respective communication protocol systems 150, 152, and 154 interfaces with the cores to provide data in the respective communication protocol. In this example, the Interlaken controller system 152 has two Interlaken controllers and respective channels. A SERDES allocator 156 allows allocation of SERDES lines through quad M-PHY units 158 to the communication systems 150, 152 and 154. Each of the controllers of the communication systems 150, 152, and 154 may access the high bandwidth memory 148.

In this example, the array 130 of directly interconnected cores are organized in tiles with 16 cores in each tile. The array 130 functions as a memory network on chip by having a high-bandwidth interconnect for routing data streams between the cores and the external DRAM through memory IO processors (MIOP) 134 and the high bandwidth memory controller 146. The array 130 functions as a link network on chip interconnection for supporting communication between distant cores including chip-to-chip communication through an “Array of Chips” Bridge module. The array 130 has an error reporter function that captures and filters fatal error messages from all components of array 130.

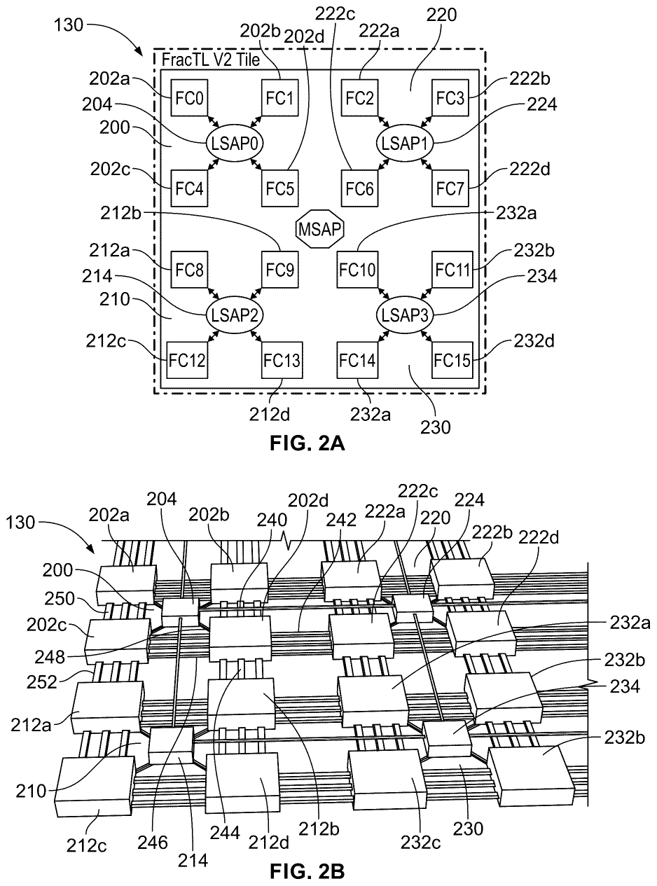

FIG. 2A is a detailed diagram of the array of cores 130 in FIG. 1B. FIG. 2B is a three-dimensional image of the array of cores 130 in FIG. 1B. The array of cores 130 is organized into four core clusters such as the clusters 200, 210, 220, and 230 shown in FIG. 2A. For example, the cluster 200 includes cores 202a, 202b, 202c, and 202d. Each of the four cores in each cluster 200 such as cores 202a, 202b, 202c, and 202d are coupled together by a router 204. FIG. 2B shows other clusters 210, 220, and 230 with corresponding cores 212a-212d, 222a-222d and 232a-232d and corresponding routers 214, 224, and 234.

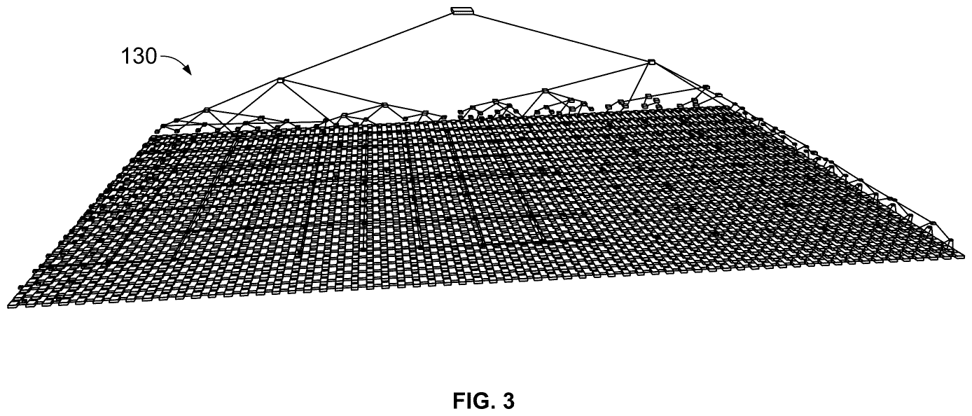

As may be seen specifically in FIG. 2B, in this example, each of the cores 202a, 202b, 202c, and 202d has up to four sets of three interconnections [Left, Aggregate, Right]. For example, a core in the center of the array such as the core 202d includes four sets of interconnections 240, 242, 244, and 246 each connected to one of four neighboring cores. Thus, core 202b is connected to the core 202d via the interconnections 240, core 222c is connected to the core 202d via the interconnections 242, core 212b is connected to the core 202d via the interconnections 244, and core 202c is connected to the core 202d via the interconnections 246. A separate connector 248 is coupled to the wire router 204 of the cluster 200. Thus, each core in the middle of the array has four sets of interconnections, while border cores such as the core 202c only have three sets of interconnections 250, 252, and 246 that are connected to respective cores 202a, 212a, and 202d. FIG. 3 is a three-dimensional view of the array of cores 130 that is suitable for selection for implementation of different operations.

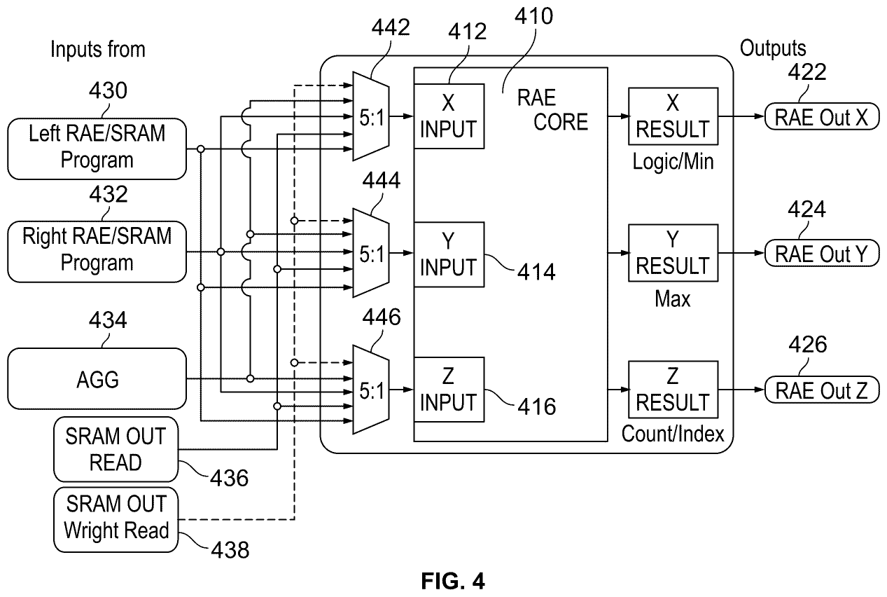

In order to configure the cores of the example array 130 in FIG. 2A, the inputs of certain blocks may be changed to configure blocks for one of the three different function blocks. The functions may be configured by simply changing the inputs of the processing cores. FIG. 4 shows a block diagram of an example processing core 400 that includes a reconfigurable arithmetic engine (RAE) 410. The RAE 410 may be configured and reconfigured to perform relevant mathematical routines such as matrix multiplications, point wise multiplication and nonlinear functions, such as Layer normalization and Softmax function, required in private LLM. The RAE 410 includes input reorder queues, a multiplier shifter-combiner network, an accumulator and logic circuits. The RAE 410 operates in several modes, such as operating as an ALU, and include a number of floating point and integer arithmetic modes, logical manipulation modes (Boolean logic and shift/rotate), conditional operations, and format conversion. The RAE 410 includes three inputs 412, 414, and 416 and three outputs 422, 424, and 426. The RAE 410 receives the output data from a program executed by another RAE 430 and output data from another program executed by another RAE 432. An aggregator (AGG) 434 provides an output of aggregated data from different sources to the RAE 410. A memory read output 436 and a memory write output 438 also provide data to the RAE 410. The memory outputs 436 and 438 provide access to a memory such as an SRAM that stores operand data, and optionally may also store configurations or other instructions for the RAE 410.

Each of the output data of the RAE 430, RAE 432, aggregator 434, memory read output 436 and the memory write output 438 are provided as inputs to three multiplexers 442, 444, and 446. The outputs of the respective multiplexers 442, 444, and 446 are coupled to the respective inputs 412, 414, and 416 of the RAE 410.

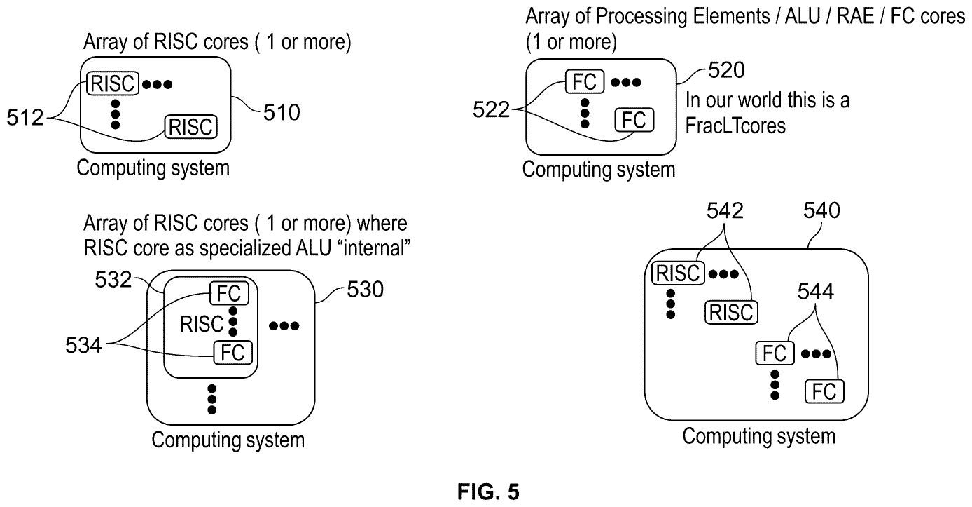

FIG. 5 is a diagram of four configurations 510, 520, 530, and 540 of the array of cores in FIG. 2B as either a RISC-V processor or a specialized ALU internal module. The configurations 510, 520, 530, and 540 can dynamically switch from one type to the other by reconfiguring some or all of the computational cores in the configurations. The first configuration 510 is a set of cores configured as a full RISC processor 512 with associated SRAM able to execute traditional Control Flow programs as a function representing the computation within a dataflow node. In this example, the RISC processor 512 includes sixteen separate cores. Another configuration 520 is sixteen independently reconfigurable and programmable ALUs, that are each cores 522 (termed FracTLcores® available from Cornami in this example). Each of the cores 522 have associated SRAM supporting multiple simultaneous integer and floating point computations of up to 128-bits. The configuration 520 thus is a set of cores that are configured as individual FracTLcores. The configuration 530 has a set of cores that is configured into two individual groupings of cores configured as RISC processors 532 and cores that are configured as ALUs (e.g., FracTLcores) 534. The configuration 540 includes one or more RISC cores 542 that are a set of sixteen cores in this example. The RISC core 542 can have additional individual or multiple FracTLcores 544 incorporated within them to accelerate specific RISC functions. Alternatively, the additional cores 544 may be designated for data path/arithmetic acceleration, enhancing ALU performance. Thus, to implement a standard 64 bit RISC processor such as the RISC-V processor 542 in this example, sixteen cores are configured to become the RISC-V. Optional additional cores may be added to the configuration to provide hardware acceleration to math operations performed by the RISC. For example, a normal RISC processor does not have hardware to perform a cosine function. Thus, an additional core may be added and configured to perform a hardware cosine operation. This enhances the ISA instruction set of the RISC processor by adding the hardware accelerated cosine function that may be accessed by the RISC processor.

Each of the cores in the array 130 may be configured for performing cryptographic operations such as encryption of ciphertext. The cores in the array 130 may also be configured to perform Boolean operations with the encrypted ciphertext without having to perform decryption, and the necessary bootstrapping to support such operations. As will be explained, the array 130 may implement a Concrete based THFE that does not require decryption to perform logical operations of encrypted ciphertext. The FHE allows computations on ciphertext without the need to perform decryption. Thus, sensitive data analysis (computations based on Boolean logic expressions) may be delegated on encrypted data.

In the below examples, the variables, c1, c2, c3, and cn are a large ciphertext (e.g., a large array of integer numbers) that have been encrypted. For example, each ciphertext represents an integer modulo p=2ⁿ for some small n (n=3, 4, 5). Ciphertexts may be added or subtracted. For typical Concrete parameters at least 3-4 additions may be performed before the noise becomes a problem requiring bootstrapping. This number of additions that may be performed without bootstrapping depends on parameters and can potentially be up to 10 or so.

Any function may be evaluated using programmable bootstrapping assuming the leading bit is known. For example, if the ciphertext is mod 8, the function where 0 is 0, 1 is 1, 2 is 2, and 3 is 3 may be evaluated for normal bootstrapping. Thus, the 3 Boolean variables in the example function require three bootstraps to perform the evaluation of the Boolean operation. The function may also be evaluated where 0 is 1, 1 is 1, 2 is 1, and 3 is 1. This automatically sends 4 to −1, 5 to −1, 6 to −1 and 7 to −1 (0≤x<4). In doing so, only one bootstrap rather than 3 bootstraps need to be performed because only a single Boolean operation is performed by assigning multiple outputs of the function are assigned to a single output value.

In Concrete, to work with Boolean values, values for true and false need to be encoded and the plaintext modulo p needs to be determined. A decision must then be made to map true and false to the integers mod p. The ciphertexts for each of the integers mod p may then be mapped as true and false and thus logical operations may be performed on the ciphertexts. Once true and false are mapped to the ciphertexts and the modulo is decided, the number of bootstraps may be reduced by evaluating Boolean operations and eliminating bootstrapping for certain Boolean operations as will be explained below.

For a standard Concrete/TFHE encoding, a modulo 8 may be used where true is 1 and false is −1. In this example, computing OR is computing c1+c2+1. The result of this is 1 or 3 if c1 OR c2 is true (either c1 or c2 is true). If c1 OR c2 is false (c1 and c2 are both false), the result is −1. If a bootstrap is performed for c1+c2+1 with a function where 1 is 1; 3 is 1, and −1 is −1, the result will be c1 OR c2. This uses one bootstrap for one Boolean operation.

In another bootstrap process, the Boolean values for c1 OR c2 OR c3 may be attempted. In this process c1+c2+c3 is computed, where −1 is false and 1 is true. If the result is −3 then all of c1, c2, and c3 are false. If the result is −1, 1, or 3, then at least one of c1, c2, or c3 is true. If programmatically the bootstrap of c1+c2+c3 is performed by a function that sends −3 to −1 and everything else to 1, the LWE encryption of c1 OR c2 OR c3 may be performed with just one programable bootstrapping. This would require one programmable bootstrapping operation instead of two programmable bootstrapping operations required with the known techniques. However this process will not work with the standard bootstrapping as explained below.

The reason for the failure of the example of setting false to −1 and true to 1 is if the modulo is 8. This is because if 3 is bootstrapped to 1, then −1=4+3 i.e., −1=7=4+3 modulo 8, where 8 is the plaintext modulo p and 4=p/2, and this expression gets bootstrapped to- 1 automatically. This is because of the requirement that the bootstrapping function is negacyclic, that is f(a)=-f(a+p/2) for all a, where p is the modulo chosen as described before. Thus, the Boolean function of c1 OR c2 OR c3 OR c4 cannot determined for mod 8 if true is assigned 1 and false is assigned −1.

The general example method reduces the need for bootstrapping to perform operations on ciphertext using Fully Homomorphic Encryption (FHE) over the Torus. A modulo is determined for a set of ciphertexts (e.g., c1, c2, c3. . . cn). False is assigned to a first value and true is assigned to a second value. Each of ciphertexts are mapped to the first value (False) or the second value (True). A Boolean expression including the ciphertexts is converted into a mathematical function. A first outcome value is assigned to the result of the mathematical function for a first result of the Boolean expression where the ciphertexts are a first combination of true or false. A second outcome value is assigned to each of a set of results of the mathematical function where the ciphertexts are combinations of being true or false. The reduced first and second outcome values of the Boolean expression are bootstrapped, thus saving the need to bootstrap each outcome value separately.

Thus, in the example method, true may be assigned 1 and false may be assigned 0 for modulo 8 where c1, c2, c3 are ciphertexts encrypting true or false. Thus, the expression c1 OR c2 OR c3 may be computed as c130 c2+c3. The result is 0 if all of c1, c2, and c3 is false. The result is 1, 2 or 3 if at least one of c1, c2, and c3 is true. Thus, if a bootstrap of c1+c2+c3 by a function that sends a result of 0 to 0 and all other results (e.g., 1, 2, or 3) to 1 is performed, LWE encryption of c1 OR c2 OR c3 may be accomplished with just one programmable bootstrap.

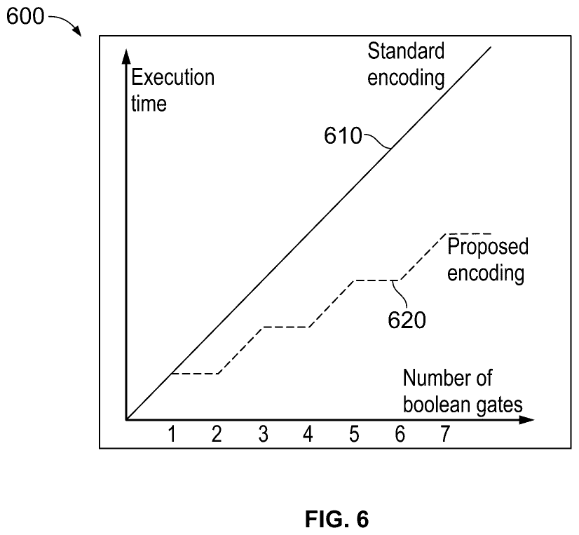

The above described technique thus reduces the required number of bootstraps required for a series of Boolean gates. This reduction is realized with expressions that require more Boolean gates. FIG. 6 shows a graph 600 of execution time in relation to number of Boolean gates. As may be seen by a plot 610 that represents standard encoding, the execution time increases with the number of Boolean gates because bootstrapping must be performed for each additional Boolean gate. A plot 620 represents the example method, that greatly reduces the execution time when the number of Boolean gates increases.

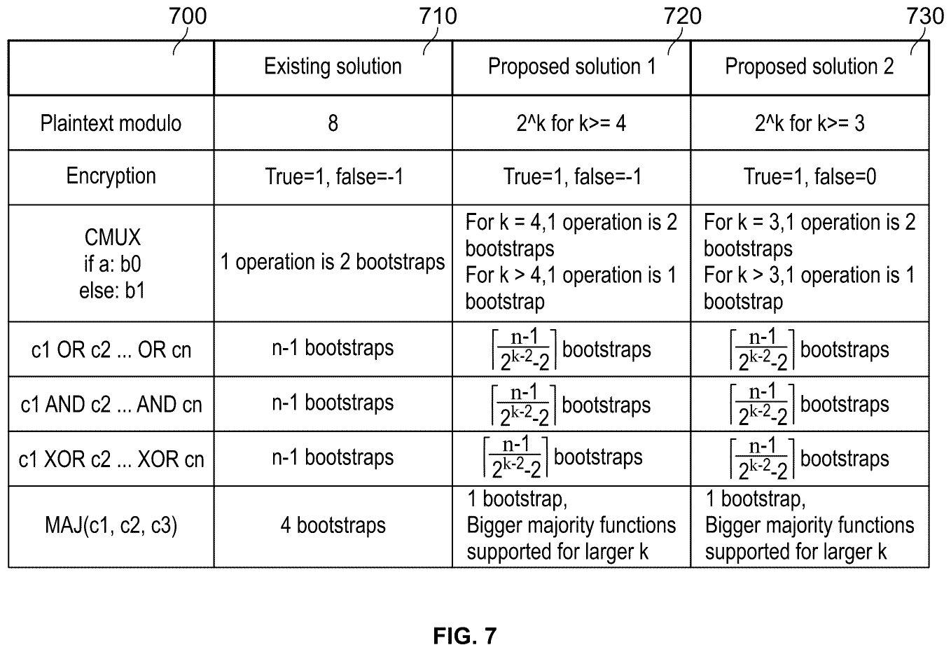

Additional Boolean operations may be performed to reduce the necessity of bootstrapping. The plaintext modulo may be changed to 16. Alternatively, the encoding may be changed to assign 0 to false and 1 to true. Together, this allows for up to 7 ORs to be evaluated with a single bootstrapping. FIG. 7 shows table 700 of different operations for reducing bootstrapping for different modules, and their comparison to the standard methods. The rows of the table 700 indicate the plaintext modulo, the encryption of true and false, the number of bootstraps for a CMUX operation, the number of bootstraps for an OR operation, the number of bootstraps for an AND operation, the number of bootstraps for an XOR operation, and the number of bootstraps for a majority function (MAJ). The majority function is a Boolean function that evaluates to false when half or more of the ciphertexts in a set are false and true otherwise.

The first column 710 shows the method currently used in Concrete/tFHE and the number of bootstraps required for the given operations with a plaintext modulo of 8 and setting true to 1 and false to −1. As shown in column 710, the CMUX operation requires 2 bootstraps, the logical operations OR, AND, and XOR in the following rows require one less bootstrap than the number of variables, and the majority function requires 4 bootstraps. Finally, the majority function requires 4 bootstraps.

In the first example of the example method shown in column 720, Boolean variables may be encoded as −1 for false and 1 for true for plaintext modulos over 8. The modulo is 2^{k} for k≥4. In this example, k is usually 4 or 5. The configuration for k=3 matches standard configuration for Boolean operations in Concrete/tFHE. As shown in column 520, the CMUX gate takes 2 bootstrapping operations for k=4 and 1 bootstrapping operation for k>4.

The OR and AND Boolean gates may be expressed in the form of c1 V c2 V c3 V . . . V cn or c1 Λc2 Λ c3 Λ. . . cn. For an XOR operation, the formulas are c1 XOR c2 XOR ... cn. The column 720 shows how many bootstraps are required to perform various Boolean operations. As shown in column 720, the OR, AND, and XOR Boolean functions have a factor of (2^{k-2}-2) fewer bootstraps than the existing method in column 710. For example, to perform c1 OR c2 OR . . . c7, one would need to perform 6 bootstrapping operations using existing methods but only one bootstrapping with proposed solution and k=5.

Another example is when the modulo is 2^{k} for k≥3 as shown in a column 730. In this example, Boolean variables are encoded as 0 for false and 1 for true. In this example, the OR and AND Boolean gates in column 730 may be performed with a factor of (2^{k-1}-2) fewer bootstraps and the XOR gates may be performed with a factor of 2^{k-1}-1 fewer bootstraps. For example, to perform c1 XOR c2 XOR . . . c8, one would need to perform 7 bootstrapping operations using existing methods but only one bootstrapping with proposed solution and k=4. Another example is computing majority gate used in an adder. Under standard technique, the majority Boolean function requires 4 bootstraps. However, with the example solution, the majority Boolean function can be implemented via a single bootstrapping for any k>2 by computing c1+c2+c3 and bootstrapping 0, 1 to 0 and 2, 3 to 1. This is because MAJ (c1, c2, c3)=1 if and only if c1 +c2+c3=2 or c1+c2+c3=3, where true is encoded as 1 and false is encoded as 0.

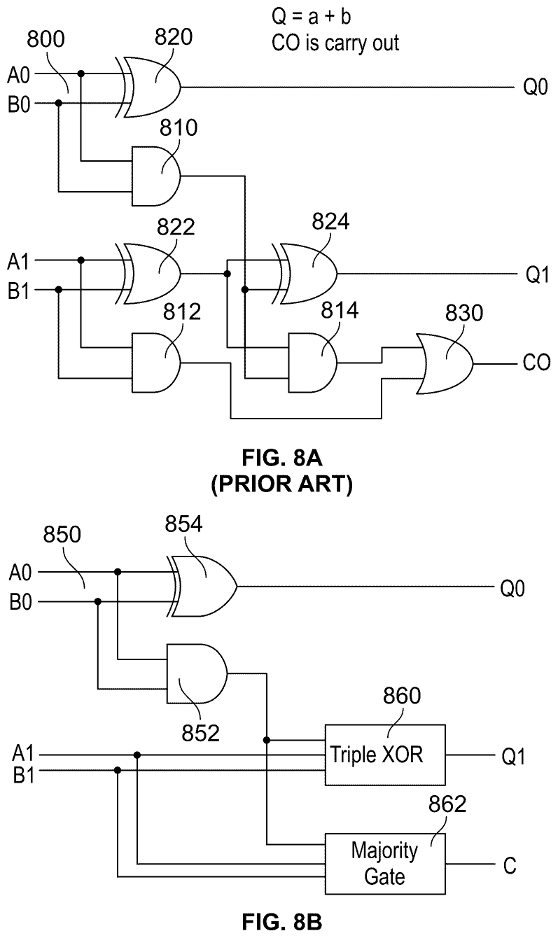

More complex structures may be configured from the basic Boolean gates described above. FIG. 8A shows an example prior art 2-bit adder 800 that is constructed from AND gates 810, 812 and 814, XOR gates 820, 822, and 824 and OR gate 830. The input is two two bit numbers (A0, A1, and B0, B1). The output is two bits (Q0 and Q1) with a carry out bit (CO) that is output by an OR gate 830. In this example, the currently used techniques would require a total of 7 bootstraps, one for each of the Boolean gates on the diagram.

With the example method described herein, the adder 800 may be redesigned to an adder 850 in FIG. 8B that requires only 4 bootstrapping operations, achieving a factor of 1.75 reduction in the number of bootstraps. The adder 850 is constructed from an AND gate 852 and an XOR gate 854. The output is the two bits (Q0 and Q1) with a carry out bit (CO). The least significant bits A0 and B0 are input into the XOR gate 854 to output the least significant output bit Q0. The least significant bits A0 and B0 are also input into the AND gate 852. The output of the AND gate 852 is coupled to one input of a triple XOR gate 860. The other two inputs of the XOR gate 860 are coupled to the most significant bits of the two numbers (A1 and B1). The output of the XOR gate 860 is the most significant output bit Q1. The output of the XOR gate 860 is also coupled to the output of a majority function gate 862. The other two inputs of the majority function gate 862 are coupled to the most significant bits of the two numbers (A1 and B1). The output of the majority function gate 862 is the carry out bit (C0). Bootstrapping is only required for the AND gate 852, XOR gate 854, triple XOR gate 860 and the majority function gate 862. Thus, the proposed method increases performance of more complex logic structures such as the adder 850. More complex logic structures may be constructed, but the required bootstraps to implement more complex logic structures may be greatly reduced by the example method.

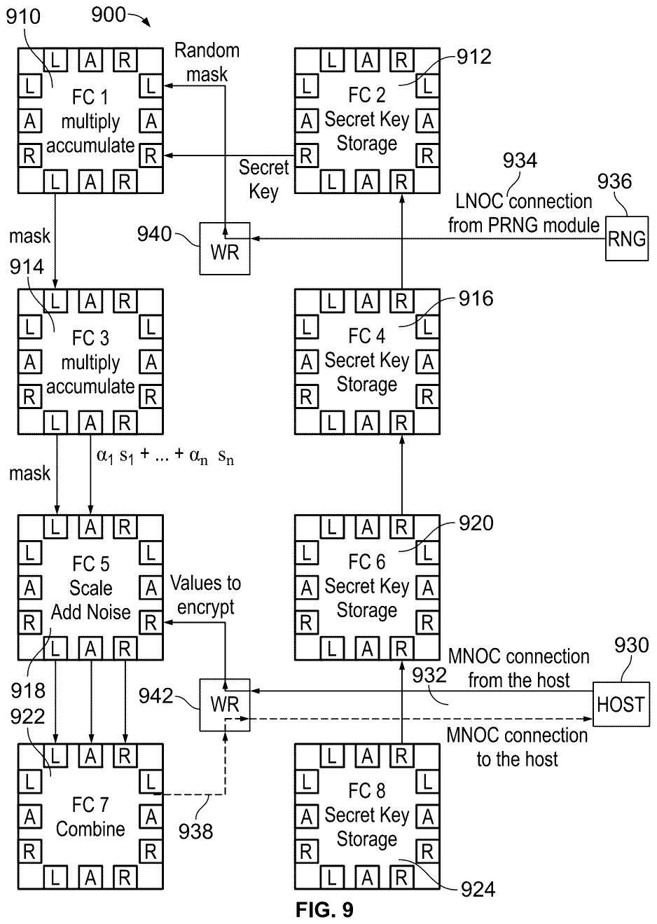

FIG. 9 shows an example configuration of the array of cores 130 in FIG. 2A that is an encryption module 900 to perform an example method of encryption that reduces bootstrapping. The configured encryption module 900 is a collection of eight cores 910, 912, 914, 916, 918, 920, 922, and 924 that is a hardware implementation of the encryption process described above. In this example, true is <−>1 and false <−>0. For this example, the plaintext modulo =2\hat{ }64. The encryption module has the following configuration-time parameters: LWE dimension n, ciphertext modulo logarithm q_log (0<q_log<63).

In this example, configuration performs the encryption process.

c_1, c_2, . . . , c_n are polynomial coefficients of the secret key.

a_1, a_2, . . . , a_n are random coefficients of the polynomial.

e is a standalone random number.
<< is a binary shift

The output (also coefficients of polynomial) is a one-dimensional vector of n+1 random numbers, where e is within a limited range. The configuration thus performs five steps. The first step is to pass the secret key from the memory. The second step is Polynomial Multiplication where (a_1*c_1+a_2*c_2+. . . +a_n*c_n) represents the sum of the result of multiplying the random polynomial by the secret key polynomial. This is a polynomial multiplication operation. The third step is a Bitwise Left Shift where m_p<<(64-q_log) involves shifting the plaintext message m_p to the left by (64-q_log) bits. This operation is typically used to adjust the position of the bits in the message. The fourth step is adding randomness, where e is a standalone random number that is added to the result of the bitwise left shift operation. This introduces additional randomness into the encryption process. The final output is the result of the encryption process, which is a one-dimensional vector that consists of n+1 random numbers. The vector's components are (a_1, a_2, . . . , a_n) followed by the result of the combined operations (m_p<<(64-q_log)+e-(a_1*c_1+a_2*c_2+. . . +a_n*c_n)).

In this example, the encryption module 900 has 3 input streams: 1) plaintext to be encrypted, either true (represented by 1 as a 64-bit number), or false (represented by 0 as a 64-bit number); 2) a secret key stream; and 3) a random number stream. In general, all three of the streams can come from any of the following sources: a host, a memory network on chip (MNOC), a link network on chip (LNOC), a core local memory such as static random access memory (SRAM), or from other cores. In the example implementation it is assumed that plaintexts to be encrypted come from the host 930 via a MNOC 932. The secret key is stored on a core local memory (SRAM) formed from the cores 912, 916, 920, and 924. A random numbers stream comes via a LNOC 934 from an on-chip pseudo-random number generator 936.

The encryption module 900 has one output stream of encrypted ciphertext 938 from the core 922. The output stream can go to any of the following destinations such as the host 930, a memory network on chip (MNOC), a link network on chip (LNOC), or to other cores. In the example the output stream is sent back to the host 930 via the MNOC 932.

Assume m_p is the plaintext, c_1, c_2, . . . , c_n is the secret key, and a_1, a_2, . . . , a_n, e is a set of n+1 random numbers (where e is in a limited range). The encryption outputs the following array: (a_1, a_2, . . . , a_n, m_p<<(64-q_log)+e-(a_1*c_1+a_2*c2+. . . +a_n*c_n)).

The configured encryption module 900 consists of the eight cores 910, 912, 914, 916, 918, 920, 922, and 924 and supports n<=2048, which covers all currently used parameters in tFHE. The implementation can be further extended to support larger LWE dimensions.

The cores 912, 916, 920, and 924 store a secret key in the respective SRAM in each of the cores 912, 916, 920, and 924. The secret key is loaded to the fabric during configuration time. In this example, each of the cores 912, 916, 920, and 924 has the capacity to store 512 64-bit values, for a maximum capacity of 2048 64-bit values on the four cores 912, 916, 920, and 924. Additional cores may be added for larger values of n. In this example, the core 912 passes all secret keys, s_1, . . . , s_n to the core 910 on the right channel. The secret keys are repeated indefinitely to allow performing as many encryptions as required by a particular application.

The cores 910 and 914 are configured in RAE pair mode, enabling them to perform s_i*a_i multiplication in 2 clock cycles. For each sample, the core 910 receives s_1, . . . , s_n on the right channel, and a_1, . . . , a_n, e on the left channel from a wire router 940 via the LNOC 934. The core 910 then computes the accumulated product sum s_1*a_1+. . . +s_n*a_n. The result is passed from core 914 to core 918 on the Aggregator channel. A random stream a_1, . . . , a_n, e is also passed from the core 914 to the core 918 on the left channel.

The core 918 receives plaintext m_p on the right channel from the host 930 via a wire router 942, and a_1, . . . , a_n, e on the left channel. The core 918 then computes m_p<<(64-q_log)+e and outputs the result on the right channel to the core 922. The core 918 also passes a_1, . . . , a_n via the Left channel to the core 922, and s_1*a_1+. . . +s_n*a_n on the aggregator channel.

The core 922 receives a_1, . . . , a_n on the left channel; m_p<<(64-q_log)+e on right channel; and s_1*a_1+. . . +s_n*a_n on the aggregator channel. The core 922 then computes m_p<<(64-q_log)+e-(s_1*a_1+. . . +s_n*a_n) and outputs final ciphertext (a_1, . . . , a_n, m_p<<(64-q_log)+e-(s_1*a_1+. . . +s_n*a_n)) on the left channel to the wire router 942 that passes the final ciphertext back to the host 930 via the MNOC 932.

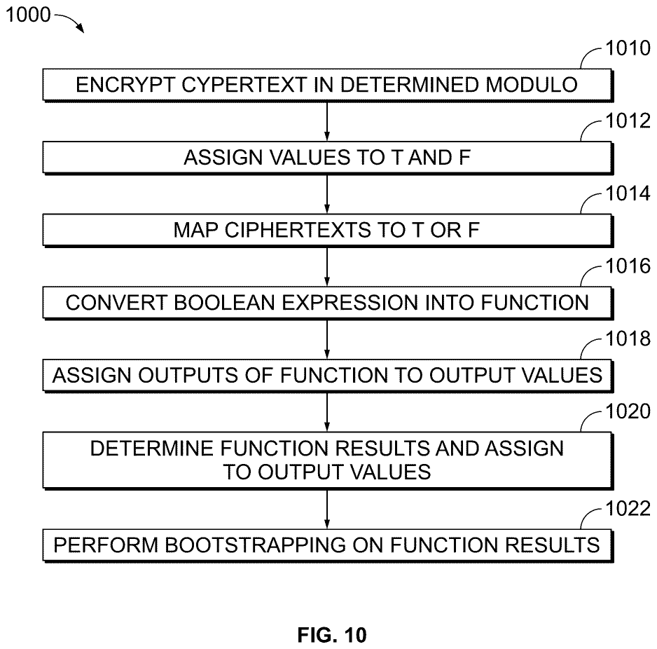

A flow diagram 1000 in FIG. 10 is representative of example machine readable instructions for the process of reducing bootstrapping of evaluating Boolean expressions in FHE Torus encryption using a Concrete library. In this example, the machine readable instructions are stored on a non-transitory computer readable medium and comprise an algorithm for execution by: (a) a processor; (b) a controller; and/or (c) one or more other suitable processing device(s). The algorithm may be embodied in software stored on tangible media such as flash memory, CD-ROM, floppy disk, hard drive, digital video (versatile) disk (DVD), or other memory devices. However, persons of ordinary skill in the art will readily appreciate that the entire algorithm and/or parts thereof can alternatively be executed by a device other than a processor and/or embodied in firmware or dedicated hardware in a well-known manner (e.g., it may be implemented by an application specific integrated circuit [ASIC], a programmable logic device [PLD], a field programmable logic device [FPLD], a field programmable gate array [FPGA], discrete logic, etc.). For example, any or all of the components of the interfaces can be implemented by software, hardware, and/or firmware. Also, some or all of the machine readable instructions represented by the flowcharts may be implemented manually. Further, although the example algorithm is described with reference to the flowchart illustrated in FIG. 10, persons of ordinary skill in the art will readily appreciate that many other methods of implementing the example machine readable instructions may alternatively be used. For example, the order of execution of the blocks may be changed, and/or some of the blocks described may be changed, eliminated, or combined.

The flow diagram 1000 is the routine for performing FHE in Torus with reduced bootstrapping. Ciphertext is first encrypted in a determined modulo value (1010). A first value is selected for true values and a second value is selected for false value based on the determined modulo value (1012). Each of ciphertexts are assigned to the true value or false value depending on their integer value (1014). The desired Boolean expression of the ciphertexts is converted into a mathematical function that provides different outputs depending on the values selected for true and false of each of the cyphertexts (1016). The outputs of the function are assigned to different output values that reduce the total number of output values of the function (1018). The results of the function are then determined and assigned to one of the reduced number of output values (1020). Bootstrapping is then performed on the results of the reduced output values (1022).

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A method to perform operations on ciphertext using Fully Homomorphic Encryption (FHE), the method comprising:
determining a modulo for a plurality of ciphertexts;
assigning false to a first value and true to a second value;
mapping each of a plurality of ciphertexts to the first value or the second value;
converting a Boolean expression including the plurality of ciphertexts into a mathematical function;
assigning a first outcome value to a result of the mathematical function for a first result of the Boolean expression where the ciphertexts are a first combination of true or false, and assigning a second outcome value to each of a plurality of second results of the mathematical function for the Boolean expression where the ciphertexts are combinations of being true or false; and
bootstrapping the reduced first and second outcome values of the mathematical function converted from the Boolean expression.

2. The method of claim 1, wherein the modulo is mod 8, and wherein the first value is 0 and the second value is 1.

3. The method of claim 2, wherein the plurality of ciphertexts are represented by c1, c2, and c3, and wherein the Boolean expression is expressed as c1 OR c2 OR c3, wherein evaluating c1+c2+c3 yields the first outcome value is a 0 if all the ciphertexts are false; and yields the second outcome value is a 1 if the results are a 1, 2, or 3 representing at least one of the ciphertexts are true.

4. The method of claim 2, wherein the plurality of ciphertexts are represented by c1, c2, and c3, and wherein the Boolean expression is a majority function of c1, c2, and c3, wherein evaluating c1+c2+c3 yields the first outcome value is a 0 if the result is 0 or 1 representing that at most one of the ciphertexts is true; and yields the second outcome value is a 1 if the results are a 2 or 3, representing at least two of the ciphertexts are true.

5. The method of claim 2, wherein the Boolean expression includes at least one of XOR, AND, or NAND Boolean operations.

6. The method of claim 2, wherein the Boolean expression is a full adder formed from XOR, AND, and Majority function Boolean operations.

7. The method of claim 1, wherein the modulo is mod 16, and wherein the first value is −1 and the second value is 1.

8. The method of claim 1, wherein the Boolean expression and encryption of the ciphertexts are performed by configured cores in an array of configurable cores.

9. The method of claim 1, wherein the cyphertexts are encrypted data, and wherein the Boolean expression is performed without decrypting the encrypted data.

10. A system to perform operations on encrypted ciphertext using Fully Homomorphic Encryption (FHE) based on a determined modulo and an assignment of false to a first value and true to a second value, the system comprising:
a first configuration of programmable cores providing encryption to create a plurality of ciphertexts and assigning the first or second value to each of the plurality of ciphertexts based on the determined modulo;
a second configuration of programmable cores converting a Boolean expression including the plurality of ciphertexts into a mathematical function and assigning a first outcome value to the result of the mathematical function for a first result of the Boolean expression where the ciphertexts are a first combination of true or false, and assigning a second outcome value to each of a plurality of second results of the mathematical function for the Boolean expression where the ciphertexts are combinations of being true or false; and
a third configuration of programmable cores performing a programmable bootstrapping to reduce noise level in the ciphertext for a specified first and second results of the mathematical function.

11. The system of claim 10, wherein the modulo is mod 8, and wherein the first value is 0 and the second value is 1.

12. The system of claim 11, wherein the plurality of ciphertexts are represented by c1, c2, and c3, and wherein the Boolean expression is expressed as c1 OR c2 OR c3, wherein evaluating c1+c2+c3 yields the first outcome value is a 0 if all the ciphertexts are false; and yields the second outcome value is a 1 if the results are a 1, 2, or 3 representing at least one of the ciphertexts are true.

13. The system of claim 11, wherein the plurality of ciphertexts are represented by c1, c2, and c3, and wherein the Boolean expression is a majority function of c1, c2, and c3, wherein evaluating c1+c2+c3 yields the first outcome value is a 0 if the result is 0 or 1 representing that at most one of the ciphertexts is true; and yields the second outcome value is a 1 if the results are a 2 or 3, representing at least two of the ciphertexts are true.

14. The system of claim 11, wherein the Boolean expression includes at least one of XOR, AND, or NAND Boolean operations.

15. The system of claim 11, wherein the Boolean expression is a full adder formed from XOR, AND, and Majority function Boolean operations.

16. The system of claim 10, wherein the modulo is mod 16, and wherein the first value is −1 and the second value is 1.

17. The system of claim 10, wherein the cyphertexts are encrypted data, and wherein the Boolean expression is performed without decrypting the encrypted data.

18. A non-transitory computer readable medium having stored thereon software instructions that, when executed by a processor, cause the processor to:
determine a modulo for a plurality of ciphertexts;
assign false to a first value and true to a second value;
map each of a plurality of ciphertexts to the first value or the second value;
convert a Boolean expression including the plurality of ciphertexts into a mathematical function;
assign a first outcome value to the result of the mathematical function for a first result of the Boolean expression where the ciphertexts are a first combination of true or false, and assign a second outcome value to each of a plurality of results of the mathematical function for a set of results of the Boolean expression where the ciphertexts are combinations of being true or false; and
bootstrap the reduced first and second outcome values of the mathematical function converted from the Boolean expression.
